(19) United States
(12) Patent Application Publication
(10) Pub. No.: US 2006/0028090 A1
(43) Pub. Date: Feb. 9, 2006

(54) Motor

(76) Inventor: Eiichi Machida, Maebashi-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/243,976

(22) Filed: Oct. 6, 2005

Related U.S. Application Data
(62) Division of application No. 10/436,271, filed on May 13, 2003, now abandoned.

(30) Foreign Application Priority Data
May 31, 2002 (JP) 2002-159181

(51) Int. Cl. H02K 11/00; H01R 39/38

(52) U.S. Cl. 310/239; 310/71

(57) ABSTRACT

A motor 11 is used for an electric power steering apparatus or the like. A power supply section 31 from which a wire harness 33 electrically connected to a brush 23 is led along the axial direction of an output shaft 12 is provided on an end surface 25a of a bracket 25 of the motor 11 in one end side of the bracket. The power supply section 31 has a power supply terminal 44 provided in a brush holder unit 24 and extending in the axial direction, a connection hole 37 opened through the end surface 25a and containing the power supply terminal 44, a terminal unit 32 attached to the connection hole 37 and having a joint terminal 34, and an O-ring inserted between the terminal unit 32 and the end surface 25a. The end surface 25a is provided with a counter lock portion 29, and the motor 11 is positioned and fixed to a gearbox. As a result, wiring can be arranged in the axial direction without bending the wire harness.

This application is a divisional application of application Ser. No. 10/436,271, filed May 13, 2003.

### BACKGROUND OF THE INVENTION

1. Field of the Invention

The present invention relates to a motor in which a power supply line is led from a bracket containing a brush holder.

2. Related Art Statement

In a small-size motor for an electric power steering apparatus (hereinafter referred to as an EPS), electric power is supplied to the motor from a battery through a wire harness (electric wire). FIG. 4 illustrates the structure of a motor for use in an EPS. As shown in FIG. 4, a wire harness 52 is extended from the outer circumference of a bracket, in the motor 51. The EPS must perfectly protect the motor from water in its installation environment in which the EPS is provided near an axle. Hence, the wire harness 52 is attached to the bracket with use of a rubber grommet 54.

The wire harness 52 is led out of the bracket 53 in a radial direction and is bent just after the rubber grommet 54, as shown in FIG. 4, if the wiring direction of the harness further extends along the axial direction. If the harness must be wired on the side of a gear box 57, the harness is wired along the gearbox and fixed by a clamp 58 because the gear box 57 has some length extending in a direction toward a counter lock portion 61. Alternatively, if the harness is wired on the side of the motor 51, the wire harness 52 is bent as drawn by a broken line in FIG. 4, and is then fixed to a yoke 56 by tape 59.

However, this motor 51 is arranged such that the wire harness 52 is led in a radial direction. Therefore, if the wire harness 52 is wired in the axial direction, the space occupied by the motor 51 increases due to a bending portion 55 of the wire harness. Suppose now that A is a minimum radius that can ensure air-tightness between the bracket 53 and the yoke 56 fixed thereto. A minimum radius necessary for installation of the wire harness 52 includes the wire-harness bending portion 55 and is therefore expressed by A+α. That is, an extra space is required for a in the periphery of the motor and hinders downsizing of the motor.

Meanwhile, if the wire harness 52 is bent and arranged in the axial direction, a gap may be created between the rubber grommet 54 and the bracket 53 or the wire harness 52 depending on how the harness is wired. If the wire harness 52 bent at the bending portion 55 is fixed by the clamp 58, the curvature R of the wire harness 52 and the clamping position are difficult to control. Consequently, an unnatural force acts between the rubber grommet and the bracket or the wire harness, like the foregoing case, so that air-tightness may be insufficient.

To prevent deterioration of sealing and ensure reliability of the motor 51, it may be necessary to reinforce the periphery of the rubber grommet 54 with a sealing material, depending on circumstances. A problem hence arises in that the production costs increase due to costs and processes for the sealing material. In particular, a silicone-based sealing material takes a long curing time, so that the items to be managed on a production line are increased to cause more costs.

### SUMMARY OF THE INVENTION

The present invention has as its object to provide a motor in which a wire harness can be wired in an axial direction without bending the harness, to achieve downsizing and improved reliability of the motor and to reduce production costs.

According to the present invention, there is provided a motor comprising: an output shaft projecting from a first end side of the motor; a bracket installed at a second end side of the motor and having a brush holder containing a brush; and a power supply section provided on an end surface of the bracket at a first end side of the bracket, with a power supply line electrically connected to the brush and led from the power supply section along an axial direction of the output shaft.

In the motor according to the present invention, the wire harness is led not in the radial direction but in the axial direction. Therefore, wiring can be arranged in the axial direction without bending the wire harness. Accordingly, the necessary minimum radius of the motor can be reduced, and no extra space is required in the periphery of the motor. As a result, the motor can be downsized.

In the motor described above, the power supply section may include: a power supply terminal provided in the brush holder, electrically connected to the brush, and having an end portion extending in a direction toward the end surface of the bracket at the first end side of the bracket along the axial direction of the output shaft; a connection hole opened in the end surface of the bracket in the first end side, with the power supply terminal inserted from a second end side of the bracket in the connection hole; a terminal attached to the connection hole, fixed to the end surface of the bracket at the first end side of the bracket, connected to the power supply line, and having a joint terminal engaged with the power supply terminal; and an O-ring inserted between the terminal and the end surface of the bracket at the first end side of the bracket, to maintain air-tightness between the terminal and the bracket.

In this structure, wiring of the wire harness can be achieved by fixing the terminal to the bracket. Therefore, endurance of the power supply section can be improved. In addition, use of a rubber grommet at the power supply section can be avoided. Accordingly, a gap which will impair sealing is not created between the bracket and such a rubber grommet due to wiring of the wire harness. Therefore, it is unnecessary to reinforce the power supply section with a sealing material, so that costs and processes for such a sealing material can be saved. Thus, production costs can be reduced.

In the motor described above, the terminal may have a shield member which air-tightly connects the power supply line. In this structure, the inside of the terminal is maintained airtight against the external atmosphere as a so-called waterproof connector, and the joint terminal is contained air-tightly in the terminal.

In the motor described above, the O-ring may be provided at an end portion of the terminal, surrounding an opening of the connection hole, and may be pressed into contact with a flat end surface of the bracket. In this structure, the O-ring is pressed into contact with the flat end surface, so that the terminal can be fixed air-tightly to the bracket in a simple reliable structure owing only to the O-ring.

In the motor described above, the terminal may be secured to the bracket by a bolt. In this structure, the terminal is securely fixed to the bracket, so that endurance of the power supply section can be improved.

In the motor described above, the power supply terminal may be inserted in and connected to the joint terminal. Since an electric connection is completed only by an operation of inserting a component, an operation of assembling the power supply section is simplified so that the man-hours required for the operations can be reduced.

In the motor described above, an engaging portion may be provided between the terminal and bracket, and the power supply terminal and the joint terminal cannot be connected to each other with polarities of the power supply terminal and the joint terminal arranged in a direction different from a regular direction. In this structure, it is possible to prevent the power supply line from being assembled in a wrong direction.

In the motor described above, a counter lock portion may be provided, together with the power supply section, in the end surface of the bracket in the first end side of the bracket, and the counter lock portion may be engaged with a device to be driven, to which the output shaft is connected and rotation of the motor is transmitted. By providing the power supply section and the counter lock portion on one same surface, the wire harness extending in the axial direction can be fixed by a vertical clamp. Accordingly, reliability can further be improved.

In the motor described above, the motor may be used for an electric power steering apparatus. By using the motor, endurance and reliability of the electric power steering apparatus can be improved, and production costs can be reduced.

The above-described and other objects, and novel feature of the present invention will become apparent more fully from the description of the following specification in conjunction with the accompanying drawings.

### BRIEF DESCRIPTION OF THE DRAWINGS

FIG. 1 is a side view showing an outer appearance of a motor according to an embodiment of the present invention;

FIG. 2 is a cross-sectional view of the motor shown in FIG. 1;

FIG. 3 is a front view of the motor shown in FIG. 1; and

FIG. 4 is an explanatory view showing the structure of a conventional motor used in an EPS.

### DESCRIPTION OF THE PREFERRED EMBODIMENT

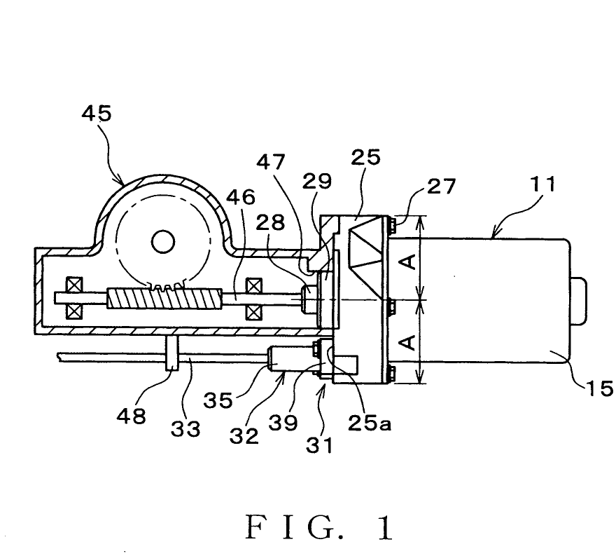

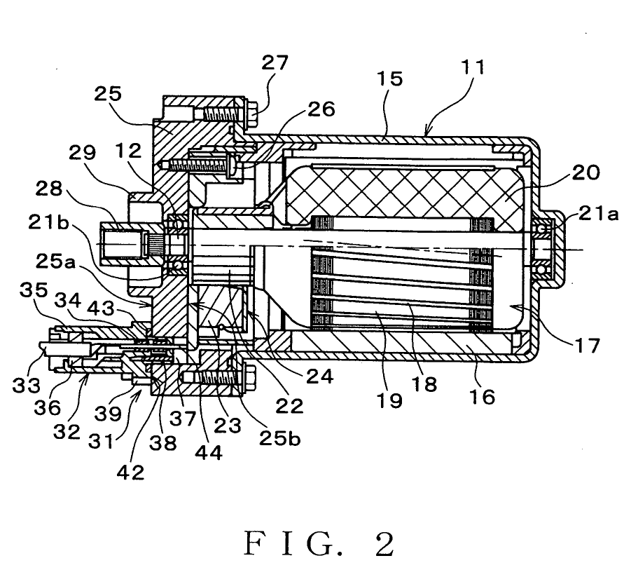

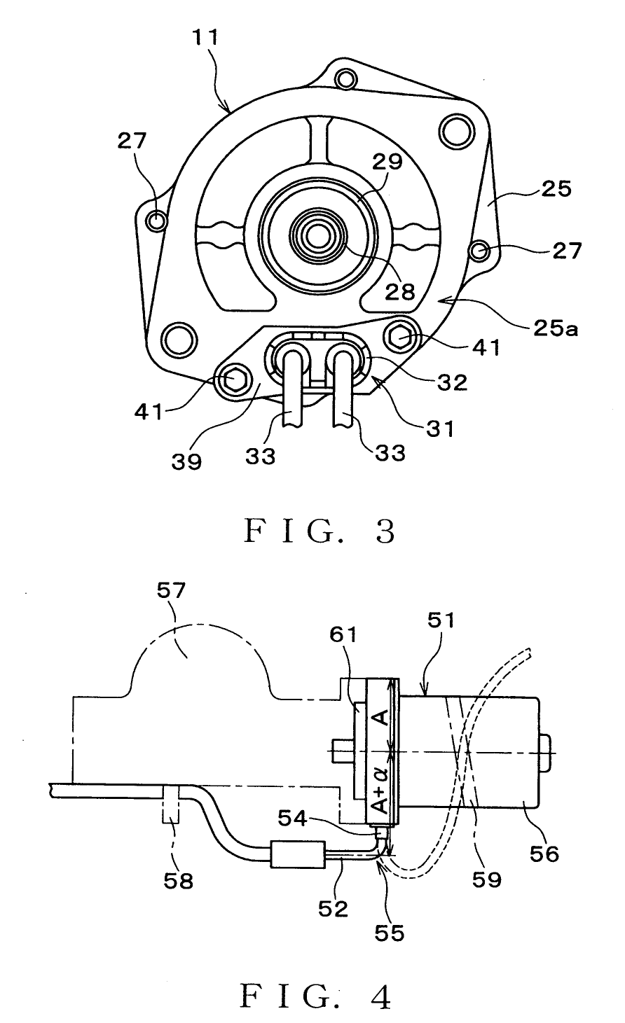

An embodiment of the present invention will now be described in detail on the basis of the drawings. FIG. 1 is a side view showing an outer appearance of a motor according to an embodiment of the present invention. FIG. 2 is a cross-sectional view of the motor shown in FIG. 1. FIG. 3 is a front view of the motor shown in FIG. 1.

The motor 11 shown in FIG. 1 is an electromagnetic motor and is used as a drive source of an electric power steering apparatus. The motor 11 has a cylindrical yoke 15, and plural permanent field magnets 16 are provided on the inner surface of the yoke. An armature 17 is rotatably provided inside the permanent field magnets 16. The armature 17 has a core 19 having plural slots 18 extending in the axial direction and coils 20 wound around the slots 18. The armature 17 is fixed to an output shaft 12 and is supported rotatably by 6 bearings 21a and 21b.

A commutator 22 is provided in the left-hand side of the armature 17 in FIG. 2. The commutator 22 is fixed to an output shaft 12. A brush 23 contacts the surface of the commutator 22. The brush 23 is held in a brush holder unit 24. The brush holder unit 24 is contained on the side of an end surface 25b (which is a second end surface) of a bracket 25, and is fixed to the bracket 25 by a screw 26. The bracket 25 is coupled with the yoke 15 by bolts 27.

The output shaft 12 is connected to an input shaft 46 of a gear box 45 by a joint 28. A counter lock portion 29 is projected and formed in the center of a first end surface 25a of the bracket 25. The counter lock portion 29 is engaged with an installation hole 47 on the side of the gear box 45. The gear box 45 is positioned relative to the motor 11 (and the bracket 25) by the counter lock portion 29 and the installation hole 47, and then, the gear box 45 is fixed to the motor 11 by a bolt or the like.

Rotation of the output shaft 12 is appropriately decelerated in the gear box 45 and then transmitted to a pinion of a steering column. Rotation of the steering column is converted into reciprocation of a tie rod by a steering gear section of rack-and-pinion type, thus controlling wheels to be steered. As a driver operates a steering wheel, the motor 11 is driven in accordance with the steering angle, driving speed of a vehicle, and the like. Accordingly, the motor 11 supplies a steering assisting force. The driver can thus operate the handle with a small force.

In the motor 11, a power supply section 31 is provided on the end surface 25a (which is the first end surface). A terminal unit 32 is attached to the power supply section 31. A wire harness 33 (which is a power supply line) is led out from the terminal unit 32 in the axial direction. That is, the power supply section 31 has a form in which the wire harness 33 is led not in a radial direction but in an axial direction. Therefore, wiring can be arranged in the axial direction without bending the wire harness 33, so that the necessary minimum radius of the motor 11 can be reduced due to non-existence of a bending portion. As a result, the motor 11 can be put in the range of the radius (2A) of the bracket 25, and no extra space is needed at the periphery of the motor. The motor can accordingly be downsized.

A joint terminal 34 connected to the wire harness 33 (power supply line) is contained in the terminal unit 32. A rubber shield (shield member) 36 is air-tightly attached to an end of the unit body 35 of the terminal unit 32. The wire harness 33 is inserted air-tightly in the rubber shield 36. As a result, the inside of the terminal unit 32 is kept airtight with respect to the external atmosphere, like a so-called waterproof connector. The joint terminal 34 is contained air-tightly in the terminal unit 32.

The terminal unit 32 is not constructed such that the wire harness 33 is sealed by a rubber tightening margin but is constructed such that the rubber shield 36 maintains air-tightness. Therefore, if only the layout of wiring the wire harness 33 can be ensured, a wire harness of any size can be attached by appropriately replacing the rubber shield 36. It is thus possible to respond easily to a request for increasing the core diameter.

A connection hole 37 is formed along the axial direction in the bracket 25. The connection hole 37 penetrates the bracket 25 and opens in the end surface 25a. An engaging portion 38 at the top end of the unit body 35 is inserted in the connection hole 37. As shown in FIG. 3, a joint portion 39 is projected and formed on the unit body 35, and is fixed to the end surface 25a by bolts 41. An O-ring 43 is attached to an end surface 42 of the joint portion 39, surrounding the opening of the connection hole 37. The terminal unit 32 is fixed air-tightly to the end surface 25a by the O-ring 43. At this time, the O-ring 43 is pressed into contact with the flat end surface 25a. Therefore, the terminal unit 32 can be air-tightly fixed to the bracket 25 by a simple and highly reliable structure using only the O-ring 43.

Meanwhile, on the side of the end surface 25b in the connection hole 37, a power supply terminal 44 electrically connected to the brush 23 is inserted. The power supply terminal 44 is provided at an end portion of a terminal plate formed integrally with the brush holder unit 24. The terminal plate is connected to the brush 23 via a pigtail, and the power supply terminal 44 is thus electrically connected to the brush 23. The power supply terminal 44 stands at right angles on the brush holder unit 24. The terminal 44 further extends toward the end surface 25a along the extending direction (or axial direction) of the output shaft 12, and is contained in the connection hole 37.

When the terminal unit 32 is attached to the bracket 25, the power supply terminal 44 on the side of the bracket 25 is engaged with the joint terminal 34 on the side of the terminal unit 32. At this time, operations of inserting components and connecting them with bolts are completed. Thus, operations for assembling the power supply section 31 are so simple that man-hours for carrying out the operations can be reduced. In addition, the endurance of the power supply section 31 can be improved because the terminal unit 32 is fixed to the bracket 25 by bolts. Further, since the power supply section 31 does not use a rubber grommet, a gap which will impair sealing is not created between the bracket 25 and such a rubber grommet due to wiring of the wire harness 33. Accordingly, it is unnecessary to reinforce the power supply section 31 with a sealing material, so that costs and processes for such a sealing material can be saved. Thus, production costs can be reduced.

In the power supply section 31, the power supply terminal 44 is male while the joint terminal 34 is female. As shown in FIG. 2, both terminals are connected by inserting the power supply terminal 44 in the joint terminal 34. The wire harness 33 and the brush 23 are thus electrically connected so that an electric power can be supplied from a battery to the motor 11 via the wire harness 33.

The power supply section 31 thus adopts a connection method based on insertion of a terminal. Therefore, an electric connection can be made simply and steadily, without necessitating spot welding at the power supply section 31. As a result, stability in quality of products can be improved. In particular, there is no need to consider the occurrence of sputtering due to an increase of the core diameter. Therefore, technical problems do not arise, and the number of items to be managed can be suppressed. Costs for increasing the core diameter can be reduced.

If the wire harness 33 is connected to the power supply terminal 44 by spot welding, the harness cannot be re-attached correctly after it is once attached incorrectly, for example, when + and − lines of the wire harness 33 have different lengths. However, this problem need not be a concern in the power supply section 31 according to the present embodiment. In this case, an engaging portion may be provided between the terminal unit 32 and the bracket 25, such that the terminal unit 32 and the bracket 25 can be coupled only in the correct direction. Then, the wire harness can be prevented from being attached incorrectly.

After thus attaching the terminal unit 32 to the bracket 25, the wire harness 33 is fixed to a side portion of the gear box 45 by the clamp 48. In the motor 11, the power supply section 31 and the counter lock portion 29 are provided on the same surface. Therefore, the wire harness 33 extending in the axial direction without skewing can be fixed by a vertical clamp. Accordingly, the curvature R of the wire harness 52 need not be managed, and the clamp position can be managed easily. In addition, vertical clamping which is ideal for a harness clamp is realized, so that holding ability of the wire harness 33 can be improved and reliability can further be improved.

Detailed description has hereinabove been given of the invention achieved by the present inventor with reference to the embodiment. However, the present invention should not be limited to the embodiment described above, and may be variously modified within the scope not departing from the gist of the invention.

The above embodiment has been described with reference to an example in which the motor according to the present invention is applied to an electric power steering apparatus. However, the motor can be applied to other electrical rotary devices. For example, the motor according to the present invention is effective for other in-vehicle motors and engines (power generators) for cars, and motors and power generators for use in industrial machines, home electric appliances, IT devices, etc.

In the motor according to the present invention, a power supply section from which a wire harness is led along the axial direction is provided on one end surface of the bracket. Therefore, wiring can be arranged in the axial direction without bending the wire harness, so that the necessary minimum radius of the motor can be decreased. Accordingly, an extra space such as a bending portion of the wire harness is not required in the periphery of the motor. The motor can thus be downsized.

The power supply section is constructed in a structure which includes a power supply terminal provided in a brush holder and extending in the axial direction, a connection hole opening through one end surface of a bracket to contain the power supply terminal, a terminal unit to be attached to the connection hole, connected to the wire harness, and having a joint terminal engaged with the power supply terminal, and an O-ring interposed between the terminal unit and the end surface of the bracket. As a result, the wire harness can be wired by fixing the terminal to the bracket, so that endurance of the power supply section can be improved. In addition, use of a rubber grommet at the power supply section can be repealed. Therefore, a gap which will impair sealing is not created between the bracket and such a rubber grommet due to wiring of the wire harness. Accordingly, it is unnecessary to reinforce the power supply section with a sealing material, so that costs and processes for such a sealing material can be saved. Thus, production costs can be reduced.

Further, the power supply section and a counter lock portion are provided on the same end surface of the bracket. Therefore, the wire harness extending in the axial direction can be fixed by a vertical clamp. Accordingly, vertical clamping which is ideal for a harness clamp can be realized, so that holding ability of the wire harness is improved and reliability is further improved.

Whata is claimed is:

1. An electric power steering apparatus including a motor operably coupled to a steering column that is adapted to be operably coupled to wheels to be steered via a tie rod so that rotation of the steering column is converted into a reciprocation of the tie rod to steer the wheels,
said motor constituting a drive source for providing steering assisting force for steering the wheels, and said motor comprising:
a motor casing having first and second ends;
a bracket having first and second end sides, said bracket being mounted at said first end of said motor casing such that said motor casing projects from said second end side of said bracket;
an output shaft extending in an axial direction through said bracket from within said motor casing so as to extend beyond said first end side of said bracket;
a brush holder mounted to said bracket at said second side thereof;
a brush contained in said brush holder;
wherein a connection hole is formed through said bracket;
wherein an elongated power supply terminal, electrically connected to said brush, is secured to said brush holder and extends in said axial direction through said connection hole of said bracket from said second end side of said bracket to a location beyond said first end side of said bracket;
wherein a gear box, formed as a separate and discrete member from said bracket, is mounted to said bracket at said first end side thereof; and
wherein said power supply terminal is disposed alongside said gear box.

2. The electric power steering apparatus according to claim 1, further comprising
a power supply line connected to said power supply terminal and extending along said axial direction.

3. The electric power steering apparatus according to claim 2, wherein
said power supply line extends along an axial extent of said gear box; and
an entirety of said power supply line that extends along the axial extent of said gear box is disposed entirely within an outer diameter of said bracket.

4. The electric power steering apparatus according to claim 2, wherein
said power supply line linearly extends along an axial extent of said gear box in said axial direction; and
a clamp fixes said power supply line to a side face of said gear box.

5. The electric power steering apparatus according to claim 1, wherein
said gear box and said power supply terminal extend from said first end side of said bracket in said axial direction at different radial locations of said bracket.

6. The electric power steering apparatus according to claim 1, further comprising:
a terminal unit fixed to said first end side of said bracket at said connection hole thereof, said terminal unit having a joint terminal engaged with said power supply terminal; and
an O-ring disposed between said terminal unit and said first end side of said bracket to maintain air-tightness between said terminal unit and said bracket.

7. The electric power steering apparatus according to claim 6, further comprising
a power supply line connected to said power supply terminal and extending along said axial direction;
wherein said terminal unit is connected to said power supply line.

8. The electric power steering apparatus according to claim 6, wherein
said terminal unit has a shield member which air-tightly shields a connection of said power supply line to said power supply terminal.

9. The electric power steering apparatus according to claim 6, wherein
said terminal unit has first and second end portions, said second end portion being mounted adjacent said first end side of said bracket;
said O-ring is provided at said second end portion of said terminal unit, surrounding an opening of said connection hole of said bracket, and is pressed by said terminal unit into contact with said first end side of said bracket.

10. The electric power steering apparatus according to claim 6, wherein
said terminal unit is secured to said bracket by a bolt.

11. The electric power steering apparatus according to claim 6, wherein
said power supply terminal is inserted in and connected to said joint terminal.

12. The electric power steering apparatus according to claim 6, wherein
an engaging portion is provided for engaging said terminal to said bracket in such a manner as to prevent said power supply terminal and said joint terminal from being connected together in an incorrect direction.

13. The electric power steering apparatus according to claim 1, wherein
a counter lock portion projects from said first end side of said bracket;
said gear box has an installation hole engaged on said counter lock portion so as to locate said gear box radially relative to said bracket; and
said output shaft is coupled with gears in said gear box so as to drive the gears.
